(19) United States
(12) Patent Application Publication
(10) Pub. No.: US 2012/0295366 A1
(43) Pub. Date: Nov. 22, 2012

(54) DIAGNOSTIC SYSTEM

(75) Inventors: Christian Zilch, Leipzig (DE); Sonya Faber, Leipzig (DE); Wilhelm Gerdes, Leipzig (DE)

(73) Assignee: FRAUNHOFER-GESELLSCHAFT ZUR FÖRDERUNG DER ANGEWANDTEN FORSCHUNG E.V., München (DE)

(21) Appl. No.: 13/388,980

(22) PCT Filed: Jul. 21, 2010
(86) PCT No.: PCT/EP2010/060573

§ 371 Date: Mar. 21, 2012

(30) Foreign Application Priority Data
Aug. 3, 2009 (DE) 102009035941.9

(51) Int. Cl. G01N 27/72; G01N 1/28; B01L 3/00

(52) U.S. Cl. 436/501; 422/500; 422/502; 422/69; 436/174

(57) ABSTRACT

The invention relates to a device for contactless control of magnetic beads on a microfluidic card by means of external magnetic fields, without having to use complicated mechanics or hydraulics. Based on a modulation of the gradient of a magnetic field, magnetic beads are lifted in a first step in a contactless way out of different reaction chambers of the microfluidic card. By means of a translation movement or a variation or modulation of the gradient of a magnetic field, horizontal transport of the magnetic beads over a mechanical barrier of the microfluidic card is facilitated in a second step. It is possible in a third step to use a further modulation of the gradient of the magnetic field to lower the magnetic beads into a desired further fluid zone.

### FIELD OF THE INVENTION

The present invention relates to microfluidic systems for probe analysis. In particular, the invention relates to a device for transporting magnetic beads on a microfluidic card, a microfluidic card for insertion in a device, as well as a method of transporting magnetic beads on a microfluidic card.

### BACKGROUND OF THE INVENTION

In case of diseases which are time-critical, a row of diagnostic systems for the local analysis of probes of patients is developed (Point of Care systems) in order to provide the findings earlier in time. These systems are commonly based on microfluidic cards, which comprise all reagents for a sample preparation, target molecule isolation and detection.

The state of the art nucleic acid and protein diagnostic systems for decentralized use at the Point of Care location comprise a plurality of mechanical and fluidic components. The complexity increases the costs and the maintenance of the systems. A further problem is the system partitioning. As a general rule, reagents and buffer fluids are stored in the reusable device, which reagents and buffer fluids are pumped into the cartridge and the microfluidic card, respectively, during the carrying out of a test. Due to the necessary fluidic interfaces between the device and the cartridge and the microfluidic card, respectively, contaminations may occur, which strongly influence the diagnostic results.

State of the art systems comprise complex and error-prone microfluidic controllers. This results in high system costs for the user, for the analyser as well as for the cartridge and the microfluidic card, respectively.

Furthermore, systems up to now work with technically error-prone valve solutions, which are partially complex to control in order to separate single reaction chambers from each other, such that no diffusion between the chambers can occur. Therein, additional external control devices are necessary, such that the valves can be managed in the desired sequence. For example, squeezing valves are used, wherein a mechanically moved spike is pressed onto the valve.

### SUMMARY OF THE INVENTION

It may be seen as an object of the invention to provide for an improved probe analysis.

A device for transporting magnetic beads from a first fluid zone into a second fluid zone of a microfluidic card, a microfluidic card as well as a method of transporting a target molecule, which is to be detected, by means of magnetic beads from a first fluid zone into a second fluid zone of a microfluidic card according to the features of the independent claims are provided. Further embodiments and advantages result from the dependent claims.

Herein described exemplary embodiments of the invention similarly pertain to the device, the microfluidic card, and the method.

It is to be noted that in the context of the present invention, the following definitions and abbreviations are used.

### Magnetic Beads:

In the context of the present invention, the term magnetic beads is used for magnetic nano- and microparticles, and the term describes carrier materials in which smaller magnetic particles are embedded. Therein, the provided device as well as the provided method may be used principally in combination with different sizes and shapes of the magnetic beads. The magnetic beads may for example be provided in a spherical form, elliptical form or polygonal form. However, any other forms shall not be excluded. Thereby it is possible, ceteris paribus, that very small magnetic beads (for example <100 nm) can only be controlled in a more difficult way via external magnetic fields within reagent fluids due to their low magnetic susceptibility compared to larger magnetic beads. Furthermore, in case of an increasing size of the magnetic beads (e.g. at a size >5 nm) the effect may play a role, that compared to smaller magnetic beads a smaller specific surface for agglomeration functional groups is provided. In other words, it may as one aspect of the present invention, that the size of the magnetic beads is selected, which size provides for an optimum with respect to the combination of the active surface and the magnetic properties of the beads. For example, magnetic beads may have a diameter, which is selected from a range from 100 nm to 5 μm, preferably the diameter may be 1 μm. However, other diameters above, below or within this range are possible. Furthermore, the invention comprises that different forms of the magnetic beads and different forms of the therein embedded nanoparticles can be used. For example, rod-shaped, wire-shaped, tube-shaped, membrane-like, irregular-shaped and ellipsoid-shaped magnetic beads and/or nanoparticles may be used. Therein, the previously explained details about nanoparticles also apply to particles, which are incorporated into the magnetic beads, which however are sized differently.

Furthermore, the present invention may make use of the fact that sphere-shaped beads provide for certain advantages in view of hydrodynamic facts.

Regarding the density of the magnetic beads, the term magnetic beads shall not comprise any limitation. For example, the magnetic beads may have a density which is larger, smaller or equal to the density of water. Furthermore, it is also possible that the density of the beads is larger, smaller or equal to the density of other used reagent liquids within the fluid zones of the microfluidic card. The density of the beads can significantly be influenced by the choice of the carrier material and the amount of magnetic particles (for example the amount of Magnetite). Thus, it is possible to choose a combination of magnetic beads and reagent liquids, at which combination the particles are provided at the bottom of the fluid zone, are swimming within the fluid or are concentrated at the surface of the reagent fluid.

Regarding the materials of the magnetic beads, a plurality of embodiments are possible according to the present invention. Overall, the magnetic beads can be of paramagnetic or ferromagnetic nature, wherein preferably paramagnetic beads with desirably low remanence and appropriate dispersion properties can be used, as these beads do not tend to aggregate in case an external magnetic field is removed. Iron oxides may be applied as magnetic materials, which in general can be described by the formula FeₓO_{y}H_{z}, (for example z=0). The regularly applied ferrites may comprise, besides iron, transition metals, such as Mn, Co, Zn, Cu and Ni, amongst others. For example, they may be based on particles of pure metals, like Fe and Co, alloys, like CoPt₃, CoPt, FePt, etc., or oxidic phases, like gamma-Fe₂O₃, FeO, NiO, and in particular the spinels Fe₃O₄, or in general M^{II}M^{II}₂O₄ (M=Fe, Ni, Co, Mn, Cr, Mg, Zn, etc.). Magnetite (Fe₃O₄, or precisely Fe^{II}(Fe^{III})₂O₄) and Maghemite (Fe₂O₃) are very well suitable for the described applications, as they provide for a high saturation magnetization (80-100 A×m²kg⁻¹). Therein, other crystallisation forms compared to the above and below described crystallisation forms shall not be understood as delimitations. The use of other crystallisation forms is explicitly possible.

Magnetic carrier materials, which represent magnetic beads, may be obtained by embedding of the separate magnetic particles in natural polymer matrices (for example, polysaccharides, like dextran, sepharose; polypeptides, like poly-L-aspartate, poly-L-glutamate; polylactides, like poly-P, L-lactide) or synthetic polymer matrices (for example, polyvinyl alcohol, polystyrene(derivative), poly(meth)acrylates (PMMA and PHEMA) and poly(meth)acrylamide, polypyrrole, polyester, poly-epsilon-caprolactam, etc., and copolymers with natural polymers) or by means of inorganic coatings (for example, SiO₂, Au, carbon). During encapsulating of magnetic particles, either small particles (for example, ferro-fluids) can homogeneously be distributed in the carrier matrix, or larger particles in from of core-shell particles can be built. A further possibility is provided by the infiltration of (organic/anorganic) porous materials by means of very small magnetic nanoparticles or solutions of Fe²⁺ and other metal ions (for example, Fe³⁺, Co³⁺, Ni²⁺, Mn²⁺, etc.) and the subsequent formation of magnetic particles (for example ferrites) in the matrix. In particular, in case of matrix-dispersed particles (“polymer beads”), the size of the beads (for example, up to 5 μm) may not be related to the size of the comprised magnetic particles (often only a few nm), which can be confirmed by measuring the curve of magnetization (small particles then show a narrow hysteresis).

As bead surfaces, polymers and well as SiO₂-coated magnetic particles can be capable of being provided with different functionalities. For example, functionalized chlorosilanes or alkoxysilanes can be bound to the SiO₂-layer (coating). In doing so, polymerization initiators (for example for the ATRP) can be coupled to the particles, in order to create typical core-shell particles with a magnetic core and a polymer shell.

These magnetic beads are commonly polymer particles with iron oxide particles or iron oxide particles with a silica coating imbedded into the polymer. The Magnetite can, for example, be provided in an amount between 10% and 90%. However, this amount may also be provided with a different value. Depending on the assembly, the amount of magnetisable particles (total magnetizability) and functionalization, the magnetic beads may be applied for different implementations. For example, in the area of life science and diagnostics, the process of cleaning nucleic acids, the cleaning of affinity of recombinant proteins or other biomolecules, and the cell separation with magnetic beads comprising an antibody coating are exemplary fields of use of the present invention. The present invention may be performed manually and/or in an automated way. Furthermore, magnetic beads with, for example, carboxy- or amino-functionalities for user-specific covalent immobilization of ligands (for example, streptavidin, protein A, antibodies, lectin, enzymes, like trypsin, benzonase) can be used.

Fluid zone:

Preferably, the term fluid zone in the context of the present invention shall be understood as a deepening within a microfluidic card, which deepening in the microfluidic card is respectively adapted for receiving the desired reagent fluids. However, the term also comprises a defined area on the surface of the microfluidic card analogue to the formation of droplets, in which area a certain amount of the respective reagent fluid is comprised due to different surface tensions. This exemplary embodiment of a fluid zone does not provide a deepening. In other words, the term fluidic zone can be understood as a continuous spatial area, in which the reagent fluid expands independently from the structure or the relief of the microfluidic card at this position.

Furthermore, the fluid zone may consist of two or more phases. For example, it is possible that one or more organic and one or more aqueous phases are simultaneously provided within one fluid zone. In the case that in the context of the present invention, a state is described at which the magnetic beads are swimming at the surface of the reagent fluid, the term fluid zone comprises a liquid phase as well as a gas phase.

### Positioning Arrangement:

Under positioning arrangement it may be understood an arrangement which positions the microfluidic card and the magnet arrangement relative to each other by means of a mechanical movement. Furthermore, it is possible, that the positioning arrangement is presented as a control arrangement or controller, which changes the magnetic field gradient, for example by controlling a magnetic field string in such a way, that a relative movement between the magnetic beads and the receiving arrangement (and therewith, also between the magnetic beads and the microfluidic card, as the microfluidic card is positioned in the receiving arrangement during operation) is created. In principle, there are various ways, how the positioning arrangement may create the relative movement. A movement of the magnet arrangement, a movement of the microfluidic card, a combination of the firstly mentioned possibilities, a change of the magnetic field gradient acting on the magnetic beads, and a combination of the previously mentioned possibilities are possible. Therein, it is possible, that by means of controlling engineering and cybernetics, the necessary movements and changes of the magnetic field gradient, respectively, are caused by the positioning arrangement.

### Contactless:

In the context of the present invention, the term contactless, in case not explicitly defined otherwise, shall be construed such that no contact between magnetic beads and the magnet arrangement in the fluid of the respective fluid zone is created. In other words, the magnet and the magnet arrangement, respectively, do not emerge or plunge into the fluid zone, but cause at least one component of movement from outside of the fluid zone by means of magnetic forces in a contactless way. A contact between the magnetic beads and the magnet arrangement, after the magnetic beads have been lifted out of the fluid zone, is however not explicitly excluded.

### Magnet Arrangement:

A magnet arrangement can be any device which provides for a magnetic field gradient for the previously and in the following described transport of magnetic beads. This arrangement can be selected from the group consisting of permanent magnet, a combination of a permanent magnet and an electromagnet, a pair respectively consisting of a combination of a permanent magnet and an electromagnet, a permanent magnet with a modulation coil, at which the magnetization of the permanent magnet is reduced by the modulation coil, as well as any combination thereof. Further parts and elements for creating the magnetic field gradient can also be comprised.

### Continuous Barrier:

The term continuous barrier and continuous mechanical barrier, respectively, provide for a distinct differentiation to valves. In other words, in the context of the present invention, fluid in a fluid zone can not get through the barrier without substantially destroying the physical matter of the barrier and without a substantial geometric change of the barrier, respectively.

### Cover Element, Bottom Element:

The terms cover element and bottom element can be understood as a cover plate and a bottom plate, respectively, but also the use of more or less elastic foils and disposable products with the aim to spatially delimit the microfluidic card upwardly or downwardly shall be comprised. Alternatively to a cover plate, an adhesive foil or a bonding sheet can be used, which does not provide an adhesive property at the positions over which the beads slide or at which the beads get into contact with the foil. Additional membranes may be used at these positions or the foil may comprise adhesive-free positions per se.

According to an exemplary embodiment of the invention, a device for transporting magnetic beads from a first fluid zone into a second fluid zone of a microfluidic card for detecting a target molecule is presented. Therein, the device comprises a receiving arrangement for receiving the microfluidic card which is to be inserted. The device further comprises a positioning arrangement and a magnet arrangement. Furthermore, the positioning arrangement is configured for generating a relative movement between the magnetic beads, which are to be transported, and between the receiving arrangement, such that the magnetic beads, which are to be transported, are transportable by the relative movement over a continuous mechanical barrier between the first and the second fluid zone of the microfluidic card. The magnet arrangement is configured to create a magnet field gradient on the microfluidic card for the relative movement of the magnetic beads with respect to at least one movement component of the relative movement, wherein the magnetic card is to be inserted into the device. The magnet arrangement is spaced apart from the receiving arrangement, such that the relative movement of the magnetic beads to be transported out of the first fluid zone with respect to at least one component of movement is performed contactless.

By means of this device, the magnet transport of the beads can be realized in a contactless way, without diffusion between the individual fluid zones of the microfluidic card. This provides for a central advantage of the present invention.

Therein the term “over” should be understood in the way that by means of the presented device, a barrier can be passed, which barrier extends perpendicular to the plane of the microfluidic card. The barrier can be passed by contactlessly lifting the magnetic beads by means of magnetic forces.

Therein, the magnet arrangement may simultaneously provide for a homogenous and an inhomogeneous field, which are superposed, such that the desired gradient of magnetic field to create the magnetic forces on the beads on the microfluidic cards is generated. These magnetic forces, which act on the magnetic beads, are used to lift the magnetic beads out of the reagent liquid of the first fluid zone in a contactless way, and are used to transport them over the mechanical barrier of the microfluidic card. By means of a modulation of the gradient of the magnetic field, the magnetic beads are subsequently inserted in the second fluid zone in a contactless way.

For example, this modulation of the gradient of the magnetic field could be applied by an electric coil current of a modulation coil of the magnet arrangement, which electrical coil current is modulated such that the desired, previously described transport of the beads over the barrier is performed, created or realized. This modulation may for example be controlled by the positioning arrangement.

Furthermore, for example, a computer program within the positioning arrangement may be provided. This computer program may be adapted to for example the microfluidic card which is to be inserted, and/or to the probe analysis to be performed, and/or to the target molecule which is to be detected.

For example, in this computer program, the sequence or the electrical current progress or development over the time can be stored, which electrical current shall run through the modulation coil in order to achieve the desired movement and/or the desired transport of the beads.

In other words, in this case, the positioning arrangement can be adapted for a controllable modulation of the coil current of the modulation coil, which may be comprised by the magnet arrangement.

For creating this relative movement, the positioning arrangement may create a movement of the magnet arrangement as well as a movement of the microfluidic card (by means of a movement of the receiving arrangement) or a combination of the previously mentioned possibilities by means of an appropriate controlling. However, it is also possible, that the positioning arrangement causes a change or a modulation of the gradient of the magnetic field such that the desired relative movement is caused. Therein, this relative movement is caused finally between the magnetic beads and the two fluid zones, which are comprised by the microfluidic card.

The relative movement comprises due to the existing barrier of the microfluidic card, which barrier is to be passed or overcome, at least two vectorial vertical and at least one vectorial horizontal component of movement. Therein, it is an important aspect of the present invention that by means of the long-distance effect or remote action of the magnetic forces between the magnet arrangement and the magnetic beads, contactless lifting of the magnetic beads out of the first fluid zone is realized.

Therein, the term spaced apart should be understood in such a way that in case the microfluidic card is in an inserted position, the magnet arrangement and the receiving arrangement are not in physical contact. In case that in an embodiment of the invention, a contact of the magnet arrangement and the receiving arrangement exists, according to the present invention at no point in time during the transport of the magnetic beads, a contact between the magnet arrangement and the fluid zone of the microfluidic card is present.

The term “regarding at least one component of movement” does further not exclude that the magnetic field is used as cause of all necessary, vectorial components of the movement. This will be explained in the following by means of the example of a series of switchable magnet arrangements.

Furthermore, it is possible, that the magnet arrangement, which may be embodied as a magnetic field array, is integrated in the cover plate or the bottom plate of a microfluidic card. In this case, conduits for controlling the gradient of the magnetic field are provided by the device for the cover plate and the bottom plate, respectively.

In other word, the present invention relates to an analysing system for applications in for example medical Point of Care analysis.

Therein, the device may comprise the microfluidic card, on which biological reactions supported by multi-functional magnetic beads, take place. Furthermore, the positioning arrangement may control the movements of the magnetic beads. Furthermore, the microfluidic card may comprise a sensor module, by means of which target molecules which are bound to the beads can be detected.

Therein, the term multi-functional beads shall be understood in the context of the invention as follows: magnetic beads with different functions are described therewith. Magnetic beads are used for isolation of biological agents, like for example microbiological pathogens, which magnetic beads provide on their surface molecules, which specifically or unspecifically get into contact with surface structures or receptors of the pathogens. Therefore, for example monoclonal antibodies (specific) or protein A (unspecific) may be used. In the procedure of isolating of nucleic acids (DNA, RNA) from the lysed pathogen surfaces which bind nucleic acids (silanes) are used commonly. Before the proof of specific sequences, a so-called polymerase-chain-reaction(PCR)-on-a-bead may be performed. Therein, oligonucleotides are used which are covalently bound to the surface of the bead, which oligonucleotides are elongated in the presence of the target sequences by means of polymerase and are subsequently detected (for example, via the corresponding oligonucleotides, which are provided in a coupled state to a microarray). Alternatively, the complete process chain of the pathogen isolation, the lysis and the nucleic acid isolation may be performed via the amplification of specific sequences and their final proof with multi-functional beads. Therein, different functionalities may be provided on the bead surface, or different functionalities are coupled inwardly of the matrix. Thus, for example, monoclonal antibodies as well as specific oligonucleotides can be coupled to the bead, which are applied in different phases during the process chain. Therein, one or more modulated magnet arrangements may be positioned over and/or under the microfluidic card. The magnet arrangements can be modulated in such a way that a gradient of the magnetic field is realized towards the bottom plate and towards the cover plate, respectively, such that depending on the concrete situation, the magnetic beads within the fluid of the first and/or the second fluid zone are moved upwards or downwards. For example, by means of a lateral shifting of the magnets or alternatively by a shifting of the microfluidic card parallel to an upward and downward movement of the magnetic beads, a lateral movement of the beads is realized. The barrier should be configured such that during a slight tilting of the microfluidic card, no mixture of the fluidic zones due to an “overflow” of the liquids takes place.

Therein, the microfluidic card may be arranged in such a way that between the individual reaction chambers, in which it is intended to provide fluid zones, barriers are provided which fluidly separate the reaction chambers from each other. Therein, the present invention avoids complicated and error-prone valve technology between the reaction chambers and the fluid zones, respectively. In order to transport the magnetic beads between the reaction chambers, the barriers must be overcome. This takes place by lifting the beads via modulating the gradient of the magnetic field. The gradient acts upwardly against the gravitation and acts in the direction of the lifting force of the beads, which acts within the reagent liquid on the beads. A horizontal movement of the magnetic beads, which is horizontal compared to the microfluidic card, can be provided by means of different, already above described ways. Therein, the positioning of the magnetic beads over the next reaction chamber, in particular over the second fluid zone is realized. Finally, the direction of the gradient is modulated downwardly, such that the beads are transported from the cover plate through the liquid in the direction of the bottom plate. Subsequently, if desired, a further modulation of the magnetic field may be performed such that the beads are moved within the reaction liquid of the second fluid zone to cause a mixing.

As the device of the present invention allows for transporting magnetic beads from one reaction chamber and one fluid zone, respectively, in the next one in a lifting way and by avoiding valve technology, the presented device is better applicable in processes which provide for strong temperature differences. In the case of a polymerase chain reaction (PCR), at which such large temperature differences occur, it may be disadvantageous to use systems with valves. Such valves are explicitly avoided by the present invention. Therefore, the device according to the present invention provides for a more temperature-resistant microfluidic analysis device, which provides for an increased lifetime, precision for example in PCR processes.

Thus, the device provides for an improved technical means to analyse multifunctional particles which are suitable for a combined molecule cleaning, a multiplex PCR reaction on beads, and on-chip hybridization for a lot of biological parameters. Therein, increased process integration and increased number of biological parameter values can be reached.

In combination with the microfluidic card, the device provides for a biochip including arrays of magneto-resistive sensors of magnetic fields, which allow for a highly sensitive quantitative proof of tiny changes of magnetic fields, which are generated by the magnetic beads. This may allow for an increased sensitivity and parallelism, compared to the level that could be reached by the prior art. Furthermore, it is possible that the microfluidic card is provided as an inexpensive disposable product based on environmentally-friendly plastic material, and is provided with a completely new microfluidic concept and lyophilised, dry-stored reagents. This ensures process integration and the possibility of long-time storage of the kits at room temperature.

In other words, the device provides for a non-contact bead control on the microfluidic card by means of external magnetic fields via an energy-saving analyser, that works without complicated mechanics or hydraulics. Thus, a high degree of miniaturization and a low-cost production is facilitated. Furthermore, a simple microfluidic is provided, which gets along without control valves. Therefore, components are saved, and the complexity of the card and of the analyser can be significantly simplified. This may lead to a command of transfers of complex essays on the device and may lead to a cost-effective production of the system components.

The device is easy to operate and allows for a fast and simultaneous detection of a lot of biological parameters, like for example with genetic predisposition cancer and different pathogens (for example HIV, bacteria and parasites). Thus, specifically trained personnel can be saved. Due to the universal and individual functionalizeable magnetic beads, a wide application field is open for the inventive device. Besides medical applications like proteomic, genomic, and microbiological tests, the present invention also expands to environmental analytical tests and to for example quality management.

Therein, this exemplary embodiment of the present device as well as every other exemplary embodiment of the device may comprise the microfluidic card. In this case, these two elements present a system for transporting magnetic beads from one first fluid zone into a second fluid zone, which system comprises the device and the microfluidic card.

According to another exemplary embodiment of the invention, the magnet arrangement comprises a modulation coil, wherein the positioning arrangement via current regulation of the modulation coil is configured for modulating the gradient of the magnetic field such that by that modulation, the magnetic beads are lifted out of the first fluid zone and are subsequently lowered into the second fluid zone.

Herewith, a contactless magnetic transport of beads in a microfluidic card can be realized, in which no diffusion at all between the fluid zones occurs due to the continuous mechanical barrier.

According to another exemplary embodiment of the invention, the gradient of the magnetic field is arranged such that by means of the gradient of the magnetic field vertical component of movement of the relative movement as well as a horizontal component of movement of the relative movement can be created/caused.

In other words, the positioning arrangement is configured to create such a gradient of magnetic field by means of controlling the magnet arrangement in a corresponding way. For example, a string of magnetic arrangements, being serially arranged, may be used. Furthermore, it is also possible to use a single magnet arrangement, which can create a magnet field which is variable in time and variable in space, such that a vertical movement of the magnetic beads out of the reaction chamber and the first fluid zone occurs.

Moreover, due to the change of the magnetic field, a horizontal movement of the magnetic beads from the lifted position above the first fluid zone towards a second position over the second fluid zone can be caused. This horizontal movement takes place parallel to the plane which is formed by the microfluidic card. Subsequently, the gradient of the magnetic field may be amended for example by means of a further modulation of the magnet arrangement such that the magnetic beads are lowered into the second fluid zone.

In this and every other exemplary embodiment of the invention, it is possible that the vertical movement of the magnetic beads out of the first fluid zone is limited and stopped, respectively, by a cover element of the microfluidic card. A subsequent horizontal movement of the magnetic beads may be performed along the surface of said cover element. In other words, the magnetic beads can be pulled over the cover element during continuous contact with the cover element by the magnetic field. After reaching the position above the second fluid zone, the magnetic beads are lowered into this area. If desired, it is also possible that the vertical movement out of the first fluid zone takes place only up to a predefined height. It is not mandatorily necessary that a contact between the magnetic beads and an upper limitation like the cover element occurs, as will be explained later-on in FIG. 3. A completely contactless transfer out of the first fluid zone into the second fluid zone is thus possible.

According to another exemplary embodiment of the invention, a device is presented in which the magnet arrangement is configured as a modulated magnet arrangement.

The modulated magnet arrangement may chosen from the group consisting of permanent magnet, combination of a permanent magnet and an electromagnet, a pair respectively consisting of a combination of a permanent magnet and an electromagnet, a switchable series of different magnets, and any combination thereof.

Therein, the above-described magnet arrangement is capable of creating/causing and providing the desired gradient of magnetic field for transporting the magnetic beads, as described previously.

The meaning of combination also comprises a permanent magnet with an electrical modulation coil, which reduces the magnetization of the permanent magnet. A corresponding modulation of the gradient of the magnetic field is realized by means of regulating the current of the modulation coil. This may for example be controlled by the positioning arrangement.

According to another embodiment of the invention, a device is presented, comprising a positioning arrangement which is capable of causing the relative movement by producing an element which is chosen from the group consisting of movement of the magnet arrangement, movement of the microfluidic card, variation of one or several gradients of a magnetic field for vertically moving the magnetic beads, variation of one or more gradients of magnetic fields for horizontally moving the magnetic beads, variation of one or more gradients of magnetic fields for vertically and horizontally moving the magnetic beads, and any combination thereof.

According to another exemplary embodiment of the present invention, the relative movement comprises, compared to the microfluidic card, a vertical component of movement and a horizontal component of movement. Furthermore, the positioning arrangement is configured for a contactless generation of the vertical component of movement by means of the gradient of the magnetic field. Furthermore, the positioning arrangement is configured for generating the horizontal component of movement by means of a movement which movement is chosen from the group consisting of translation of the magnet arrangement, translation of the microfluidic card, horizontal movement of the magnetic beads, which is generated via switching through a series of different magnet arrangements, and any combination thereof.

According to another exemplary embodiment of the invention, the magnet arrangement is configured for generating the vertical as well as horizontal movement of the magnetic beads, such that the transport of the magnetic beads from the first fluid zone into the second fluid zone is facilitated entirely by the gradient of the magnetic field. Furthermore, the positioning arrangement is configured to correspondingly control the magnet arrangement.

According to another exemplary embodiment of the invention, the positioning arrangement is configured to generate the relative movement based on a geometrical distribution of the fluid zones on the microfluidic card.

In other words, it is possible to provide digital data to the positioning arrangement, which digital data provide for the distribution of the fluid zones. Based on the provided information, the positioning arrangement selects an appropriate measure, by means of which the positioning arrangement causes the relative movement and controls the relative movement, respectively.

According to another exemplary embodiment of the invention, the device provides for a modulation arrangement, which is capable of mixing fluids within at least one of the two fluid zones.

The modulation arrangement may be embodied as the positioning arrangement. Firstly, the magnetic beads may be kept in their position by the gradient, and the microfluidic card is activated to perform a movement, which leads to the desired mixing. Secondly, it is also possible to keep the microfluidic card at a fixed position, for example by the modulation arrangement, and to cause a modulation of the gradient in desired frequency and amplitude, such that the magnetic beads perform a swirl movement in the desired fluid zone. Due to the friction between the magnetic beads and the fluid a mixing of the fluid is caused.

According to another exemplary embodiment of the invention, a microfluidic card for insertion into a device according to a previously described or below described embodiment of the present invention is presented, which device is enabled for transporting magnetic beads on the microfluidic card. The microfluidic card provides at least a first and a second fluid zone, wherein the first and second fluid zones are respectively arranged for being filled with a fluid and a target molecule. Therein, the first and second fluid zones are separated by a mechanical barrier, which is a continuous barrier.

Therein, the barrier may be arranged such that the beads mechanically slide in a desired way over the surface of the barrier and do not get caught on the barrier. A certain predefined throatiness of the surface of the barrier may be provided.

According to another exemplary embodiment of the invention, the microfluidic card provides for a cover element and/or a bottom element and provides for a magnet arrangement for providing a gradient of a magnetic field, wherein the magnet arrangement is integrated into the cover element or the bottom element. Furthermore, the magnet arrangement comprises a modulation coil, wherein the first and the second fluid zones are arranged for being filled with a fluid and a target molecule, wherein the first and the second fluid zones are separated by a mechanical barrier.

Therein, the mechanical barrier is a provided as a continuous barrier, and the magnet arrangement is configured to modulate the gradient of the magnetic field such that the magnetic beads are lifted out of the first fluid zone and are subsequently lowered into the second fluid zone.

By means of the microfluidic card, which is connected to a positioning arrangement as described above via for example electrical leads, it is possible by means of modulation of the gradient of the magnetic field to cause a horizontal and vertical movement of the beads, which movement lifts the magnetic beads over the continuous mechanical barrier. In other words, the beads can be lifted out of the plane of the fluid zones with such a card, and after performing a parallel horizontal movement they can be lowered into the plane of the fluid zones, for example into the second fluid zone. Therein, the lifting and lowering is performed in a contactless way as already described and as will be described in the following.

According to another exemplary embodiment of the invention, the microfluidic card provides for a sensor arrangement, wherein the sensor arrangement is configured to detect magnetic beads.

For example, magneto-resistive sensors for magnetic fields are provided on or in the microfluidic card, which sensors allow for a highly sensitive quantitative proof of tiny changes of magnetic fields, which are caused by single magnetic beads. This allows for an increased sensitivity and parallelism compared to state of the art measuring methods. As a sensor arrangement, for example a Hall probe or GMR and TMR sensor arrays (giant or tunnel magneto-resistance sensors, respectively) that are specifically designed for biological applications, may be applied, by means of which magnetic beads may be detected in a very sensitive and parallel way. At the magnetic beads, one or also a plurality of target molecules can be coupled, which molecules in turn can bind on a few up to several thousands of sensor fields, for example on a CMOS sensor array. After binding of the magnetic beads to the sensor surface, the local magnetic field (if necessary after magnetising by for example an external homogeneous magnetic field) of the beads can be detected by the sensor element, as it gets noticeable via a change of resistance at the sensor element, which for example may be read out and evaluated completely electronically.

For example, the sensor arrangement may be positioned in the ultimate or penultimate fluid zone of the microfluidic card. In order to transport the magnetic beads to the individual positions of the capture molecules placed on the sensors (spots), special meander- or wave-shaped microfluidic arrangements of the chambers may be chosen. Non-bound beads can be transported into a waste or collecting chamber (in this case as ultimate fluid zone) by means of external magnetic fields in which chamber they no more influence the magneto-resistive measuring.

According to another exemplary embodiment of the invention, the sensor arrangement is chosen from the group consisting of magneto-resistive chip, sensor using the anisotropic magneto-resistive effect, sensor using the giant magneto-resistive effect, sensor using the colossal magneto-resistive effect, sensor using the magneto-tunnel resistance, piezo-sensor, capacitive sensor, electrochemical sensor, optical sensor, CCD chip, and any combination thereof.

According to another exemplary embodiment of the invention, the microfluidic card comprises a bottom element and a cover element. In a received position, the bottom element is substantially parallel to and is below the fluid zones. However, the cover element of the microfluidic card is in a received position substantially parallel to and is above the fluid zones. Therein, the cover element is arranged such that it provides for an upper limitation of a vertical component of movement of the relative movement of the magnetic beads out of at least one of the fluid zones of the microfluidic card. Furthermore, the cover element is configured such that a guidance for a horizontal component of movement of the relative movement of the magnetic beads is provided.

Therein it is possible that the microfluidic card comprises a bottom element and/or a cover element.

Furthermore, the microfluidic card according to another exemplary embodiment is arranged in such a way that the bottom element and/or the cover element are physically separated from the plane of the microfluidic card in which the fluid zones are provided. This third plane can for example be provided by means of a main card body of the microfluidic card. Therefore, in this case, the microfluidic card is embodied in two or three pieces.

Therein, the respectively comprised element, the bottom- and/or cover element can be attached to the main card body in a removable way.

Therein, the cover element as well as the bottom element may be arranged as a plate. Alternatively, also an adhesive foil may be used which is not adhesive at the positions over which the beads slide and get into contact with the foil, for example by means of fixed membranes. The use of adhesive-free positions is also possible. As can be seen from the following FIG. 2, such a cover element can be used for guiding the transport of the magnetic beads parallel to the microfluidic card.

According to another exemplary embodiment of the invention, the microfluidic card provides for a separate magnetisable body for being placed in one of the two fluid zones and for magnetically binding the magnetic beads.

An advantage of this embodiment is to provide for one or more magnetisable balls or differently shaped bodies in the reaction chambers (for example, iron balls) and to reduce the minimum of the magnetic field strength, which is necessary for the transport of the beads. The material should thereby be arranged in such a way that without external magnetic field no magnetization is provided, which means the body is so non-magnetic that the magnetic beads do not bind to the separate magnetisable body. Otherwise, the magnetic beads would be attracted by the ball without switching on the external magnetic field (of the external gradient of magnetic field). The magnetic transport of the beads shall only be performed when the external magnetic field is switched on.

The separate magnetisable body is magnetized due to the presence of the external magnetic field such that the magnetic beads are attracted. The body with the adherent functionalized beads is moved from the first fluid zone (the first reaction chamber) into the second fluid zone (the next reaction chamber). After the external magnetic field is switched off, which may be performed by for example removing the permanent magnet and by switching off the electrical magnetic coil, respectively, the beads which were connected at the separate magnetisable body are released into the reagent liquid. For example, as a separate magnetisable body, an iron ball may be used.

According to another exemplary embodiment of the invention, a system is provided which comprises a device according to one of the previously or in the following described embodiment of the invention and a microfluidic card according to a previously described or in the following described exemplary embodiment of the invention.

According to another exemplary embodiment of the invention, a method of transporting a target molecule which is to be detected and which is transported by means of magnetic beads from a first fluid zone into a second fluid zone in a microfluidic card is presented. The method comprises the step of inserting a microfluidic card comprising at least a first fluid zone and a second fluid zone into a receiving arrangement. The first fluid zone and the second fluid zone are separated by a mechanical barrier. Furthermore, the mechanical barrier is a continuous barrier. As further steps, the method provides transferring the magnetic beads into the first fluid zone, generating a gradient of a magnetic field by means of a magnetic arrangement such that the gradient of the magnetic field extends onto the microfluidic card for moving the magnetic beads, generating a relative movement between the magnetic beads, which are to be transported, and the receiving arrangement, wherein at least one component of the relative movement is generated by means of the gradient of the magnetic field. As a further step, the method comprises transporting the magnetic beads out of the first fluid zone by means of at least one component of movement, wherein the transporting of the magnetic beads with the at least one component of movement is performed in a contactless way.

By means of this method, a magnetic transport of the beads is performed in a contactless way, without the occurrence of diffusion between the individual fluid zones of the microfluidic card. This represents a central advantage of the present invention.

Therein, transferring may also be understood as inserting, introducing or placing the magnetic beads in the first fluid zone.

With the method according to the present invention, a closed system can be used in which all reagents are comprised, which are necessary for e.g. nucleic-acid- and protein-diagnostics. Thus, findings can be provided earlier, in particular in the case of diseases which are time-critical. Furthermore, the method according to the present invention allows to renounce complicated and error-prone control steps. This may reduce system costs for the user.

In other words, a non-contact bead control is possible, which does not necessarily imply the use of complex mechanics and hydraulics. A complex valve controlling can be completely avoided according to this method.

According to another exemplary embodiment of the invention, the method provides for the step of regulating a current of a modulation coil for modulating the gradient of the magnetic field in such a way that by the modulation the magnetic beads are contactlessly lifted out of the first fluid zone and are subsequently lowered into the second fluid zone in a contactless way.

For example, the controlling of the current of the modulation coil can be performed by the positioning arrangement. This may for example be carried out on the basis of a computer program which is stored in the positioning arrangement, wherein correspondingly different current strength depending on the time are provided in the computer program for the modulation coil.

Therein, the modulation of the gradient is performed by increasing or decreasing the electrical current of the coil in the modulation coil.

According to another exemplary embodiment of the invention, the relative movement comprises a first vertical component of movement compared to the microfluidic card, and a second vertical component of movement and a horizontal component of movement. Furthermore, this exemplary embodiment comprises the further method steps of firstly varying the generated gradient of magnetic field in such a way that the first vertical component of movement is caused, by means of which the magnetic beads are lifted out of the first fluid zone. A further step is the generation/causing of the horizontal component of movement in such a way that the magnetic beads are moved horizontally and relative to the microfluidic card, by means of which the magnetic beads are positioned above the second fluid zone. A further step is the second varying of the generated gradient of magnetic field in such a way that the second vertical component of movement is caused such that the magnetic beads are lowered in the second fluid zone.

Therein, by causing a component of a movement, the generation of a corresponding movement along the orientation and direction of this component of movement is meant. Therein, the horizontal component of movement may be generated such that the magnetic beads either glide over the mechanical barrier in physical contact or that they glide along a cover element in a guided way.

According to another exemplary embodiment of the invention, the method comprises the steps of: positioning a separate magnetisable body in the first fluid zone, magnetising the separate magnetisable body, binding magnetic beads to the separate magnetisable body, wherein the relative movement applies to the magnetic beads as well as to the separate magnetisable body.

For example, a paramagnetic ball may be provided in the reaction chamber of the microfluidic card. It may be seen as an advantage, that the necessary external magnetic field is lowered compared to the situation without the separate magnetisable body in order to transport the magnetic beads.

According to another exemplary embodiment of the invention, the method further comprises the step of removing the gradient of the magnetic field such that the separate magnetisable body loses its magnetisation and the magnetic beads are released in the second fluid zone.

After switching off the external magnetic field and the gradient of the magnetic field, respectively, which may for example be performed by removing the permanent magnet or by switching off the coil current of a magnet coil, magnetic beads which have been collected at the iron ball are released again and are directed into the solution of the reagent liquid.

According to another exemplary embodiment of the invention, the method further comprises the step of modulating a field strength of the gradient of the magnetic field in such a way that a mixing of the liquid by means of magnetic beads in one of the fluid zone is caused.

Such a modulation may for example be performed by the positioning arrangement or by an additional modulation arrangement. Therein, a bead movement, for example a swirl movement, is caused, which is caused by the modulating control of the external magnetic field and the gradient of the magnetic field, respectively.

According to another exemplary embodiment of the invention, the method comprises the step of completing the detection of a target molecule which is provided at the magnetic beads by means of a magnet sensor which is provided in the last fluid zone.

For this final detection of the target molecule by means of the detection of magnetic beads, very low concentration of target molecules can be detected, which are bound at the magnetic beads, due to the sensitivity for tiny changes of the magnetic field. Therefore, at the individual sensor elements of the magnet sensor, specific capturing molecules are coupled (for example oligonucleotides, monoclonal antibodies, haptens, zinc finger proteins, etc.), which may interact with the target molecules that are provided at the bead. Thus, the beads bind to the corresponding positions (spots) of the magnetic sensor. Due to the change of local acting magnetic fields above the sensor element, which change is caused by the magnetic bead, a detection of the bound beads by means of the magneto-resistive sensor element is possible. This can be provided via a change in resistance at the respective sensor element, which is noticed by a change of the flow at constant voltage at the sensor element (in case of an amperometric measurement). This change in current can be recorded metrologically. A specific sensor embodiment comprises a CMOS logic below the sensor layer by means of which the signals can be amplified, digitised and multiplexed directly on a micro-chip. In such a way, realising of thousands of tiny sensor elements (sensor array) on a small area (10 mm²-1 cm²)) s possible, which detect single-bound beads and which provide a digital signal via a serial interface to a readout device.

According to another exemplary embodiment of the invention, the method comprises the step of generating the first fluid zone with water after flooding chambers which are loaded with reagents in dry form.

In other words, it is possible with this method step to provide lyophilised, dry-stored reagents in microfluidic card.

According to another exemplary embodiment of the invention, the method comprises the step of creating a movement of the magnetic beads by modulating the gradient of the magnetic field in a such way that the solving of the dry-stored reagents in a solvent within the fluid zones is accelerated.

Therein, for example the positioning arrangement may amend the gradient of the magnetic field by modulating the current in the modulation coil such that the desired movement of the beads within a fluid zone is generated, and the solving is accelerated. Thereby, horizontal and/or vertical component of movement may be generated.

In the following, exemplary embodiments of the present invention will be described with reference to the figures.

### BRIEF DESCRIPTION OF THE DRAWING

FIGS. 1 to 5 show schematic, two-dimensional representations of a device for transporting magnetic beads on a microfluidic card according to different exemplary embodiments of the invention.

FIG. 6 shows a schematic, two-dimensional representation of a flow diagram, which represents a method according to an exemplary embodiment of the invention.

The representations in the figures are schematically and not in scale.

In the following figure description, the same reference numerals are used for the same or similar elements.

### DETAILED DESCRIPTION OF EMBODIMENTS

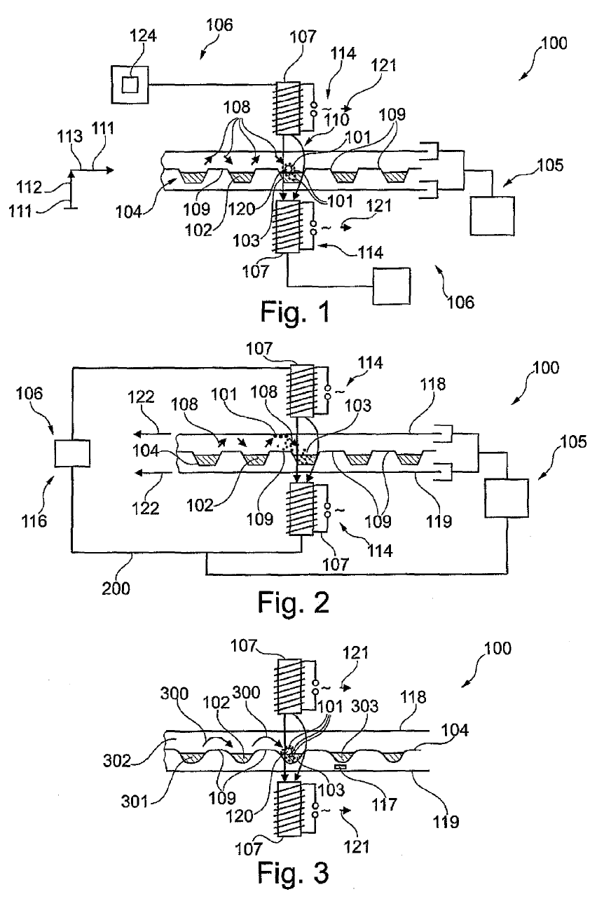

FIG. 1 shows a device 100 for transporting magnetic beads 101 from a first fluid zone 102 into a second fluid zone 103 of a microfluidic card 104 to be inserted. This may be used for detecting a target molecule of the magnetic detection of magnetic beads. Therein, a receiving arrangement 105 for receiving the microfluidic card is shown. Therein, the receiving arrangement can be adapted for mechanically holding as well as for moving and positioning the microfluidic card relative to the magnet arrangement 107. Furthermore, two positioning arrangements 106 above and below the microfluidic card are shown, which respectively control a magnet arrangement 107, which are also positioned above and below the microfluidic card and which are controlled regarding their movement and the generation of the gradient of the magnetic field. The gradient of the magnetic field is shown symbolically with 110. Therein, the two magnet arrangements 107 shown in FIG. 1 are exemplarily shown as a combination of a permanent magnet and an electromagnet 114. However, it would be possible in this and every other exemplary embodiment of the invention to only use one magnet arrangement.

Therein, the device 100 and the microfluidic card 104 constitute a system for transporting the magnetic beads 101 by the modulation of the gradient of the magnetic field.

Furthermore, by means of the arrows 121, a movement of the respective magnet arrangement is shown. This movement can, if desired, be controlled by the positioning arrangement 106 two-dimensionally along the plane, which is spanned by the microfluidic card 107.

For example, it is possible to predefine within a storage device 124 a geometrical distribution of the fluid zones of a respective microfluidic card in a digital way. Subsequently, the positioning arrangement may cause relative movement between the microfluidic card 104 and the magnet arrangement 107 based on the geometrical distribution of the fluid zones. But also an amendment of the gradient of the magnetic field 110, which is generated by the magnet arrangement 107, is controllable in such a way and therewith modulated in such a way that finally, the desired relative movement 108 between the magnetic beads to be transported and the receiving arrangement is caused. In the light of the plurality of possible ways of creating a relative movement between the magnetic beads to be transported and the receiving arrangement, the transport of the beads over the continuous mechanical barrier 109, which barrier is part of the microfluidic card, is a core aspect of the present invention.

Therein, FIG. 1 shows two components of movement 111 of the relative movement 108. A vertical component of movement 112 and a horizontal component of movement 113 of the relative movement 108 are shown. In other words, the magnetic beads 101 are lifted out of the first fluid zone 102 in a vertical direction due to the gradient of magnetic field, and by means of movement of the magnet arrangement along arrows 121, the horizontal component of movement 111 is caused. Doing so, the magnetic beads are positioned above the second fluid zone 103. Subsequently, a downward movement of the magnetic beads along the vertical direction into the reagent fluid of the second fluid zone is caused. This downward movement is caused via a modulation of the gradient of magnetic field, which modulation is controlled also by the positioning arrangement 106.

Furthermore, a separate magnetisable body 120 is shown in FIG. 1, which serves for magnetic binding and connecting, respectively, of the beads. Therein, the body may for example be manufactured as magnetisable ball of steel, which is provided in the reaction chamber. The material may thereby be configured in such a way that without an external magnetic field, no magnetization is present, i. e. the ball is completely non-magnetic. However, slight modifications thereof are also possible. Otherwise, the magnetic beads would be attracted by the ball without switching on an external magnetic field. The magnetic bead transport should only occur, when the external magnetic field is switched on. When switched on the steel ball is magnetised, such that the magnetic beads are attracted.

The steel ball with the adherent functionalized beads is transported in sequence from the first fluid zone 102 to the second fluid zone 103. In this way, the necessary external magnetic field for the necessary transport of the magnetic beads to be accomplished is smaller compared to the situation without a steel ball. After switching off the external magnetic field, or also after reducing the external magnetic field, for example by removing a permanent magnet or by reducing or switching of the current of a magnet coil, the collected beads at the steel ball are released again and are directed in the solution of the second fluid zone 103. Therein, it is an important aspect of this exemplary embodiment of the invention, that at no time during the transport, a mechanical contact between firstly the beads and magnet arrangement and secondly between the magnet arrangement and the fluid zones is established. In this meaning, the transport is carried out contactless.

By means of the device shown in FIG. 1, a magnetic transport of the beads can be performed in a contactless way, such that no diffusion between the individual fluid zones of the microfluidic card occurs.

Furthermore, a method could be carried out in which the generation of a movement of the magnetic beads is provided by a modulation of the gradient of the magnetic field in such a way that the solving of dryly stored reagents in a solvent within the fluid zones is accelerated.

Therein, for example the positioning arrangement may amend the gradient of the magnetic field by current modulation of the modulation coil, such that the desired movement of the beads within the fluid zones is caused and the solving is accelerated. Therein, horizontal and/or vertical components of movement can be caused.

FIG. 2 shows a further exemplary embodiment of the invention, which shows a device 100 for transporting the magnetic beads 101 from a first fluid zone 102 into a second region 103 of the microfluidic card 104. In this embodiment, the relative movement 108 between the magnetic beads to be transported and the receiving arrangement 105 is caused by the positioning arrangement 106 which in turn causes via control leads 200 the receiving arrangement 105 to move the microfluidic card 104 along the shown arrows 122. Therein, the magnet arrangements 107 are also embodied as a combination of a permanent magnet and a modulation coil as in FIG. 1. Therein, the modulation coil can be used to variably reduce the magnetisation of the permanent magnet. Furthermore, it is also possible that the magnet arrangement 107 glides along the cover element 118 of the microfluidic card, and on the bottom element 119, respectively.

In this case, a direct contact between the magnet arrangement and the microfluidic card would exist. However, for the entire invention it is of importance that no contact firstly between the magnet arrangement and the fluid zones during the complete transport of the beads exists, and secondly also during the complete transport of the beads, no contact between the magnetic beads and the magnets exists. Furthermore, it is also possible, if desired, that the magnet arrangement is integrated in for example the cover element 118. For this embodiment, mechanical contact between magnetic beads and the magnets would exist, however, also in this and in every other of the present invention, contact between the magnet arrangement and the fluid in the fluid zones 102 and 103 is avoided.

It is further also possible that the microfluidic card comprises also only a bottom element or also only a cover element.

Furthermore, in this embodiment one can seen that a non-contact bead control via external magnetic fields is possible, which does not need complicated mechanics or hydraulics. Furthermore, the application of error-prone valves can be avoided by the present invention.

FIG. 3 shows a device 100 for transporting magnetic beads over a barrier 109, which the microfluidic card 104 comprises between the first and the second fluid zones 102 and 103. FIG. 3 shows that during the transport of the magnetic beads the mechanical barrier is passed due to a change of the height of the magnetic beads compared to the surface of the card 104.

In other words, by means of magnetic forces, each magnetic bead to be transported is provided with higher potential energy, to overcome the barrier without any problem by means of a further generated translation.

FIG. 3 therein describes with the circular arrows 303, which describe the relative movement between the magnetic beads to be transported and the receiving arrangement (not shown here), that also a transport of the beads is possible, in which neither a contact of the beads on the cover element 118 of the microfluidic card, nor at the barrier 109 must occur. In other words, the magnetic beads are completely lifted from the first fluid zone 102 into the second fluid zone 103 of the microfluidic card in a contactless way. Thereby, the magnet arrangement 107, whose gradient of magnetic field causes the vertical component of movement by means of modulation, can be moved along the arrows 121 relative to the microfluidic card.

FIG. 3 shows a sensor device 117, which is integrated into the microfluidic card. This sensor device may be embodied as a Hall sensor, for example, which allows for a highly sensitive quantitative detection of tiny changes of magnetic fields within the third fluid zone 303. This change of magnetic field may be caused by individual magnetic beads. Furthermore, it is possible that the sensor device is embodied as, for example, as magneto-resistive chip, as piezo-sensor, as capacitive sensor, as electrochemical sensor, as optical sensor or also as CCD chip. FIG. 3 also shows that a first phase 301, which is provided in the microfluidic card liquid, above which a gas phase 302 is provided.

In other words, the magnetic beads during a transport process over the mechanical barrier 109 may move through a first liquid, then a gaseous, and afterwards again into a liquid phase. Therein, it is also possible that the liquid phase consists of several liquid phases, for example consists of an organic and a aqueous phase.

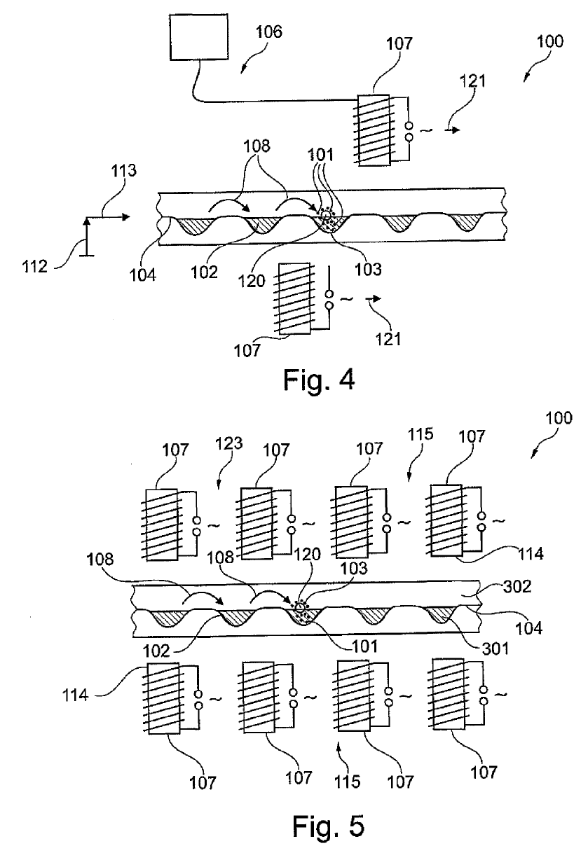

FIG. 4 shows a device 100, with which magnetic beads 101 can be transported and positioned in several dimensions in a contactless way in a microfluidic card 104. The two shown magnet arrangements 107 generate a gradient of magnetic field, with which a first vertical movement of the beads out of the first fluid zone 102 may be caused. By means of a movement 121 of the magnet arrangement 107 relative to the microfluidic card, a second horizontal component of movement 113 of the magnetic beads 101 is generated. These are bound to a separate magnetisable body 120 in this embodiment. By means of the combination of a modulation of the gradient of the magnetic field and the translation of at least one magnet arrangement 107 relative to the microfluidic card 104, the desired dynamics of the magnetic beads is generated. Subsequently, a modulation of the magnetic field gradient (not shown here) can be used for lowering the magnetic beads 101 in the second fluid zone 103. Subsequently it is possible, if desired, to pull the second lower magnet arrangement 107 to the height of the first magnet arrangement. This is shown by the lower arrow 121.

FIG. 5 shows a device 100, which besides a microfluidic card 104 comprises a series 115 of switchable different magnet arrangements 107.

In this exemplary embodiment, the magnet arrangements are respectively embodied as a combination of a permanent magnet and an electrical modulation coil, as shown. In each case, above and below the microfluidic card, a part of the pair of magnet arrangements is positioned. By means of this configuration it is possible, via a corresponding control of the magnetic arrangements, to vary a magnetic field gradient, such that the vertical as well as the horizontal movement of the magnetic beads 123 is caused. In other words, it can be avoided, that movable mechanisms for positioning the receiving arrangement and/or for positioning the magnet arrangements must be used. This may mean an improved miniaturization and integration of the device into other systems.

Also in this embodiment, it is shown that the magnetic beads 101 bind to a separate magnetisable body 120, and the latter can be used as transport bus. Therein, the magnetic beads get from the liquid phases 301 into the gaseous areas 302, after which they are again lowered in for example the second fluid zone 102 into a water aqueous solution or for example an organic solution.

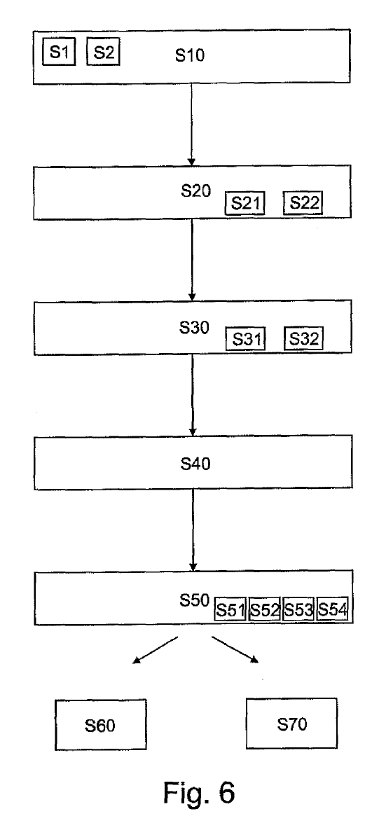

FIG. 6 shows a flow diagram which depicts a method according to another exemplary embodiment of the invention. Therein, the method serves for transporting a target molecule to be detected by means of magnetic beads from one first fluid zone into a second fluid zone of a microfluidic card. The method comprises the following steps: inserting a microfluidic card with at least one first fluid zone and one second fluid zone in a receiving arrangement, which step is termed with S10.

Therein, the first and the second fluid zone are separated by a mechanical barrier. The mechanical barrier is a continuous barrier, which does not comprise any valve. Step S20 describes the transfer of the magnetic beads in the first fluid zone, and step S30 describes the step of generating a magnetic field gradient by a magnet arrangement in such a way that the magnetic field gradient extends to the microfluidic card for moving the magnetic beads. The generation of the relative movement between the magnetic beads to be transported and the receiving arrangement is provided with step S40. Therein, at least one component of movement of the relative movement is created by the gradient of the magnetic field. The step S50 describes the transporting of the magnetic beads out of the first fluid zone by means of the at least one component of movement. Therein, the transporting of the magnetic beads is provided by means of the at least one component of movement in a contactless way.

FIG. 6, in addition to the previously mentioned method steps, shows further steps which can be applied for, between or also after the previously mentioned method steps. For example, it is possible by means of step 51 to create the first fluid zone by flooding water to the chambers which are loaded with dry reagents.

In such a way it is possible, by means of step S2, to provide a device on the microfluidic card, wherein the device can comprise the target molecule and the magnetic beads, which are transported in the first fluid zone of the card by magnetic forces. Therein it is not decisive for the core aspect of the invention, how the beads and the target molecule get to the microfluidic card. In other words, each method by means of which the beads are positioned shall be combinable with the present invention.

Furthermore, a magnetizable separate body, for example a steel ball can be placed in the first fluid zone by means of step S21. Before the transport of the magnetic beads as well as after such transport, it is possible to apply a modulation of the strength of field of the gradient of magnetic field in such a way that a mixing of the fluids by means of the magnetic beads in one of the fluid zones is realized. This is shown with the steps S22 and S 16 in FIG. 6. Therein, before the transport via the gradient of magnetic field provided by the magnet arrangements, the separate magnetisable body is magnetised. This is described by step S31. Due to the magnetism of the magnetic beads, they bind in for example the first fluid zone to the separate previously magnetized bodies during the step S32. In case the transport movement of the magnetic beads is considered in detail, a first varying of the generated magnetic field gradient is performed during the method. The varying is performed in such a way, that the first vertical component of movement is caused, by means of which the magnetic beads are lifted out of the first fluid zone. This is described by method step S51. Furthermore, the horizontal component of movement is generated in such a way that the magnetic beads are moved horizontally and relative to the microfluidic card, by means of which the magnetic beads are positioned over the second fluid zone, which is provided with step S52. The method step S53 describes a second varying of the generated magnetic field gradient.

Therein, the second varying is performed in such a way that the second vertical comprises of movement is caused, by means of which the magnetic beads are released in the second fluid zone. If desired, subsequently by means of step S54, the magnetic field gradient can be removed such that the separate magnetisable body loses its magnetization, and the bound magnetic beads are released in the second fluid zone. After one or several such previously described transport movements of the magnetic beads, final detection of the target molecules at the magnetic beads may be performed during step S70, by means of a magnet sensor that is provided in the last fluid zone.

It shall explicitly be noted, that a certain selection of method steps may be performed in another sequence as described herein, without departing from the core aspect of the present invention.

In addition, it should be noted that “comprising” does not exclude other elements or steps, and “a” or “an” does not exclude a plurality. Furthermore, it should be noted that features of steps, which have been described with reference to one of the above exemplary embodiments, can also be used in combination with other features or other steps of other above described exemplary embodiments of the invention. Reference signs in the claims should not be construed as limiting the scope of the claims.

1-20. (canceled)

21. A device for transporting magnetic beads from a first fluid zone into a second fluid zone of a microfluidic card, which is to be inserted, for detecting a target molecule; the device comprising:
a receiving arrangement for receiving the microfluidic card, which is to be inserted;
a positioning arrangement;
a magnet arrangement;
wherein the positioning arrangement is configured to generate a relative movement between the magnetic beads, that are to be transported, and between the receiving arrangement in such a way, that by means of the relative movement the magnetic beads, that are to be transported, are transportable over a continuous mechanical barrier between the first and the second fluid zone of the microfluidic card, which is to be inserted;
wherein the magnet arrangement is configured to generate a gradient of a magnetic field on the microfluidic card, which is to be inserted, for the relative movement of the magnetic beads, that are to be transported, with respect to at least one component of movement of the relative movement; and
wherein the magnet arrangement is spaced apart from the receiving arrangement in such a way, that the relative movement of the magnetic beads, that are to be transported, out of the first fluid zone is provided in a contactless way with respect to the at least one component of movement.

22. The device of claim 21, wherein the gradient of the magnetic field is configured in such a way that by means of the gradient besides a vertical component of movement of the relative movement also a horizontal component of movement of the relative movement can be generated.

23. The device of claim 21, wherein the magnet arrangement is arranged as a modulated magnet arrangement which is chosen from the group consisting of permanent magnet; combination of a permanent magnet and an electromagnet; a pair respectively consisting of a combination of a permanent magnet and an electromagnet; a switchable series of different magnet arrangements, and any combination thereof.

24. The device of claim 21, wherein the positioning arrangement is arranged to facilitate the relative movement by generating one of the elements, which is chosen from the group consisting of movement of the magnet arrangement, movement of the microfluidic card, variation of one or of more gradients of a magnetic field for vertically moving the magnetic beads, variation of one or more gradients of a magnetic field for horizontally moving the magnetic beads, variation of one or more gradients of the magnetic field for vertically and horizontally moving the magnetic beads, switching through a series of different magnet arrangements, and any combination thereof.

25. The device of claim 21, wherein the relative movement comprises a vertical component of movement and a horizontal component of movement relative to the microfluidic card, which is inserted;
wherein the positioning arrangement is configured for contactlessly generating the vertical component of movement by means of the gradient of the magnetic field; and
wherein the positioning arrangement is configured for generating the horizontal component of movement by means of a movement, which movement is chosen from the group consisting of translation of the magnet arrangement, translation of the microfluidic card, horizontal movement of the magnetic beads, which is generated by means of a switching through of a series of different magnet arrangements, and any combination thereof.

26. The device of claim 21, wherein the magnet arrangement is configured for generating a vertical as well as a horizontal movement of the magnetic beads, which movement facilitates the transport of the magnetic beads from the first fluid zone in the second fluid zone completely by means of the gradient of the magnetic field; and
wherein the positioning arrangement is configured to control the magnet arrangement correspondingly.

27. The device of claim 21, wherein the positioning arrangement is configured for generating the relative movement based on a geometrical distribution of fluid zones on the microfluidic card.

28. The device of claim 21, the device further comprising:
a modulation arrangement for mixing of fluids in at least one of the two fluid zones.

29. A microfluidic card for inserting in a device according to one of claims 1 to 8 for transporting magnetic beads on the card; the microfluidic card comprising:
at least a first fluid zone and a second fluid zone;
wherein the first and the second fluid zone are correspondingly adapted for being filled with a liquid and a target molecule;
wherein the first and the second fluid zone are separated by a mechanical barrier; and
wherein the mechanical barrier is a continuous barrier.

30. The microfluidic card of claim 29, further comprising:
a sensor device;
wherein the sensor device is configured for detecting a magnetic bead.

31. The microfluidic card of claim 30, wherein the sensor device is chosen from the group consisting of magneto-resistive chip, sensor using the anisotropical magneto-resistive effect, sensor using the giant magneto-resistive effect, sensor using the colossal magneto-resistive effect, sensor using the magneto-tunnel resistance, piezo-sensor, capacitive sensor, electrochemical sensor, optical sensor, CCD chip, and any combination thereof.

32. The microfluidic card of claim 29, the microfluidic card further comprising:
a cover element;
a bottom element;
wherein the bottom element in an inserted state of the microfluidic card is positioned essentially parallel to and is positioned below the fluid zones;
wherein the cover element in the inserted state of the microfluidic card is positioned essentially parallel to and is positioned above the fluid zones;
wherein the cover element is arranged as an upper limitation for a vertical component of movement of the relative movement of the magnetic beads out of at least one of the fluid zones of the microfluidic card; and
wherein the cover element is configured for providing guidance for a horizontal component of movement of the relative movement of the magnetic beads.

33. The microfluidic card of claim 29, further comprising:
a separate magnetisable body for being placed in one of the two fluid zones and for magnetically binding the magnetic beads.

34. A method for transporting a target molecule, which is to be detected, by means of magnetic beads from a first fluid zone into a second fluid zone of a microfluidic card, wherein the method comprises the steps:
inserting a microfluidic card with at least a first fluid zone and a second fluid zone, which are separated by a mechanical barrier, into a receiving arrangement;
transferring magnetic beads into the first fluid zone;
generating a gradient of a magnetic field by a magnet arrangement in such a way that the gradient of magnetic field extends on the microfluidic card for moving the magnetic beads;
generating a relative movement between the magnetic beads, that are to be transported, and between the receiving arrangement;
wherein at least one component of movement of the relative movement is generated by the gradient of magnetic field; and
transporting the magnetic beads out of the first fluid zone by means of the at least one first component of movement, wherein the transporting of the magnetic beads is performed by the at least one component of movement in a contactless way.

35. The method of claim 34, wherein the relative movement comprises relative to the microfluidic card a first vertical component of movement, a second vertical component of movement and a horizontal component of movement;
the method further comprising the steps:
firstly varying the generated gradient of magnetic field such that the first vertical component of movement is caused, by means of which the magnetic beads are lifted out of the first fluid zone;
generating the horizontal component of movement such that the magnetic beads are moved horizontal and relative to the microfluidic card, by means of which the magnetic beads are positioned above the second fluid zone; and
secondly varying the generated gradient of magnetic field such that the second vertical component of movement is caused, by means of which the magnetic beads are lowered into the second fluid zone.

36. The method of claim 34, the method further comprising the steps:
providing a separate magnetisable body in the first fluid zone;
magnetising the separate magnetisable body by means of the gradient of magnetic field generated by the magnet arrangement;
binding the magnetic beads to the separate magnetisable body;
wherein the relative movement applies to the magnetic beads as well as to the separate magnetisable body.

37. The method of claim 36, the method further comprising the step:
removing the gradient of magnetic field such that the separate magnetisable body loses a magnetisation and such that the separate magnetisable body releases the bound magnetic beads in the second fluid zone.

38. The method of claim 34, the method further comprising the steps:
modulating a strength of field of the gradient of the magnetic field such that a mixing of the fluid by means of the magnetic beads is caused in one of the two fluid zones.

39. The method of claim 34, further comprising the step:
finally detecting target molecules being provided at the magnetic beads by means of a magnet sensor which is provided in a last fluid zone.

40. The method of claim 34, further comprising the step:
generating the fluid zones by means of water after flooding chambers which are loaded with reagents provided in a dry form.
